(19) United States
(12) Patent Application Publication
(10) Pub. No.: US 2014/0007587 A1
(43) Pub. Date: Jan. 9, 2014

(54) Aircraft Maintenance Apparatus

(71) Applicant: TRONAIR INC., Holland, OH (US)

(72) Inventors: Paul A. Spinazze, Toledo, OH (US); Peter Heydinger, Toledo, OH (US); Wayne Grebe, Whitehouse, OH (US); Jason Borgess, Sylvania, OH (US); Rodney Wallace, Holland, OH (US)

(73) Assignee: TRONAIR INC., Holland, OH (US)

(21) Appl. No.: 13/751,654

(22) Filed: Jan. 28, 2013

Related U.S. Application Data
(60) Provisional application No. 61/668,166, filed on Jul. 5, 2012.

(51) Int. Cl. F02C 9/16

(52) U.S. Cl. CPC F02C 9/16
USPC 60/787

(57) ABSTRACT

This Mobile Driven Hydraulic Power Unit (HPU) provides a source of clean, pressurized hydraulic fluid for performing required aircraft maintenance. The unit sits on a heavy duty towable frame designed for off-road terrain. Electric start engine, fully instrumented operation panel for both the engine and hydraulic system. A gasoline engine or diesel engine may be used to power the HPU.

### CROSS REFERENCE TO RELATED APPLICATION

The present patent application is based upon and claims the benefit of provisional patent application No. 61/668,166, filed on Jul. 5, 2012.

### FIELD OF THE INVENTION

The present invention relates to the field of aviation and, more particularly, to the maintenance of aircraft.

### BACKGROUND OF THE INVENTION

Various aircraft maintenance equipment has been developed for maintaining various portions of an aircraft. Aircraft ground servicing, specifically, provides electrical, hydraulic fluid, and gaseous inputs to aircraft at or on remote locations. An aircraft on the ground whose engine is not functioning requires a number of services to determine whether the aircraft is in a condition to fly or taxi. These services include: electrical power, hydraulic power, engine-start capability (bleed-air), air conditioning or heating of the aircraft's interior, and nitrogen to inflate struts and operate power tools.

The present invention is based on the technical problem of making it possible to use a hydraulic fluid supply unit with little operational and maintenance effort, and at the same time be functionally safer and more universal.

### SUMMARY OF THE INVENTION

The present invention provides an apparatus that overcomes the deficiencies of the prior art in ground servicing of aircraft The present invention provides a single, self-powered unit that combines all the components necessary to service a variety of aircraft without requiring power from the aircraft or an electrical source.

In one preferred embodiment, the present invention is a Mobile Driven Hydraulic Power Unit using a gasoline or diesel engine. The Mobile Hydraulic Power Unit (HPU) provides a source of clean, pressurized hydraulic fluid for performing required aircraft maintenance. The engine drives a pressure compensated piston pump. Filters are provided on the pressure and return systems. A bypass (dump) valve allows starting and stopping of the unit under a no-load, safe condition. The unit may use either the aircraft or on-board HPU reservoir. Cooling is provided for continuous operation. The unit sits on a heavy duty towable frame designed for off-road terrain. Electric start engine, fully instrumented operation panel for both the engine and hydraulic system, and a multi hour fuel tank are included.

The unit is an apparatus for servicing an aircraft, comprising a mobile vehicle; a service unit detachably mounted to the vehicle; hydraulic fluid aircraft servicing outputs.

In one preferred embodiment, the HPU uses a diesel engine and has an operating range up to 4000 psi. The other preferred embodiment the HPU uses a gas engine and has an operating range up to 1800 psi.

Other objects and advantages of the present invention will become apparent to those skilled in the art upon a review of the following detailed description of the preferred embodiments and the accompanying drawings.

### IN THE DRAWINGS

FIG. 1 is a side view of Mobile Driven Hydraulic Power Unit of this invention using a gasoline engine.

FIG. 2 is a side view of an HPU according to this invention using a diesel engine.

FIG. 3 is a view of the control panel for the HPU of FIG. 2.

FIG. 4 is a graph showing the operating range of the diesel driven HPU.

FIG. 5 is a general view showing a typical aircraft.

### DETAILED DESCRIPTION OF THE INVENTION

### Example I

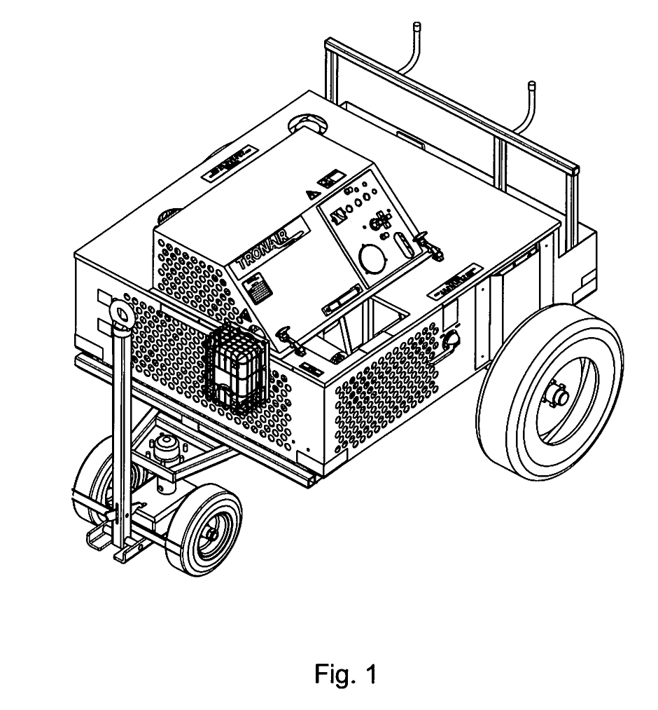

FIG. 1 is a side view of Mobile Driven Hydraulic Power Unit of this invention. FIG. 1 shows that the Mobile Driven Hydraulic Power Unit (HPU) provides a source of clean, pressurized hydraulic fluid for performing required aircraft maintenance. A gasoline engine drives a pressure compensated piston pump. Filters are provided on the pressure and return systems. A bypass (dump) valve allows starting and stopping of the unit under a no-load, safe condition. The unit may use either the aircraft or on-board HPU reservoir. Cooling is provided for continuous operation. The unit sits on a heavy duty towable frame designed for off-road terrain. Electric start engine, fully instrumented operation panel for both the engine and hydraulic system, and an 5 hour fuel tank are included.

### FLUID: MIL-PRF-5606 OR MIL-PRF-83282

### ENGINE: 18 HP TIER II 2 CYLINDER GASOLINE ENGINE

### PUMP: 6 GPM, 250-1800 PSI HYDRAULIC PRESSURE COMPENSATED

### FILTRATION: 2 MICRON PRESSURE, 5 MICRON RETURN

### FEATURES:

MOTOR SPARK ARRESTOR

OIL AND HYDRAULIC FLUID COOLERS

RESERVOIR SELECTOR VALVE

6 GALLON, 5 HOUR FUEL TANK

TRAILER TOWBAR AND LOCKING BRAKE

DUAL SCALE FLOWMETER AND PRESSURE GAUGE

30 FT PRESSURE AND RETURN HOSES

ELECTRIC START, HOURMETER, TACHOMETER

### Example II

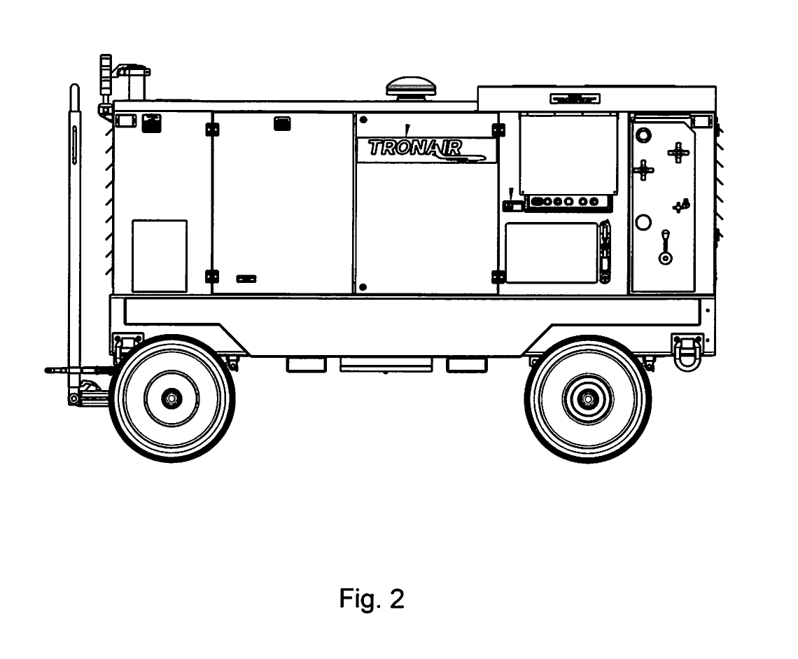

FIG. 2 shows a side view of an HPU according to this invention using a diesel engine.

This diesel engine driven hydraulic power unit has the following features:

Cummins, QSB4.5P130, Tier 3, 130 HP, 1800 rpm diesel engine (Jet-A or diesel fuel)

0-34 gpm, 250-4000 psi, flow and pressure ratings

Hydraulic System Meters: Digital (0.1% FS) flow meter, digital (0.25% FS) pressure gauge, digital (0.5% FS) temperature gauge

Engine System Monitor: Back lit digital display and diagnosis (DOD)

With hour meter, and LED indicator lights
The engine DDD is a multifunctional tool, which displays many engine-operating parameters including oil pressure, oil temperature, running hours, RPM, coolant temperature and fuel consumption. For the technician, the DDD can display service reminders for filter replacements, active fault cods and stored service codes for easy engine maintenance and diagnostics

Hydraulic Operation and Controls
Hydraulic system open or closed loop via four way selector Valve
Pressure Control Valve
Flow Control Valve
Bypass Valve for loading and unloading the hydraulic pump
Hand Pump Gauge
Pressure Gauge Calibration Port
Calibration Port Shut Off Valve
Selector Valve to select between aircraft or HPU reservoir

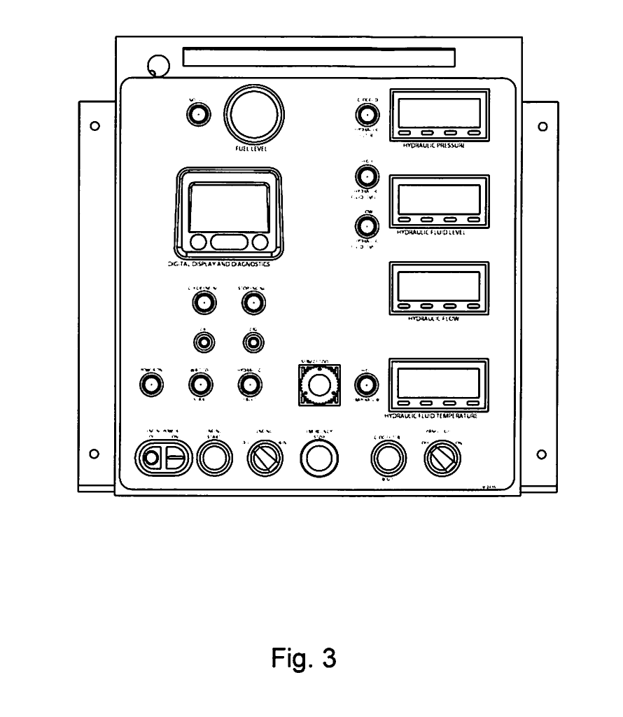

FIG. 3 shows a view of the control panel for the diesel driver HPU. Features of the control panel include:

User friendly engine control panel for easy operation, includes service tool socket

Pressure Filtration: 2 micron, non-bypass type (beta rating >200 @ 2 micron)

Return Filtration: 5 micron, bypass type (beta rating >300 @ 5 micron)

70 gallon stainless steel hydraulic reservoir with desiccant breather, drain valve, and air removal system

Large forced air cooler (20+ HP heat removal) hydraulic heat exchanger, thermostat controlled cooling system

Convenient hangers and trays to hold and contain the hydraulic hoses when not in use on the aircraft

24 volt, dual battery for cold weather starts

Engine block and grid heater cold weather system

Reservoir Service/Component Testing: Manual two stage hand pump (high volume/5000 psi) with 2 micron, non-bypass type (beta rating >200 @ 2 micron) pressure filter

Ruggedized frame with enclosed fork lift tubes and 10,000 lb tie down rings

Running gear rated for 8500 lbs. and 10 mph, Four wheel Ackerman steering with leaf spring trailer towing system with two wheel parking brake

Bright LED lighting on engine and hydraulic instrument panels, and unit corner lights for night operation

Large 35 gallon fuel tank for 12+ hours of use

Hydraulic fluid sample port for contamination testing

Quiet Operation: Less than 85 dbA at three feet noise level

Easy access, light weight, removable pin hinged panels for full access to all maintenance components

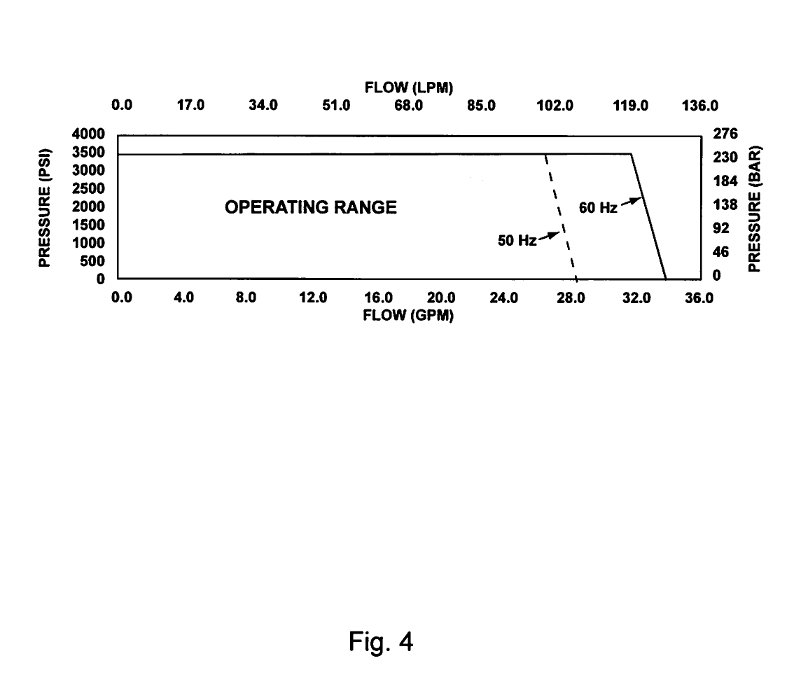

FIG. 4 is a graph showing the operating ranges for the diesel driven HPU. Safety features include:

Hydraulic high and low reservoir shutoff feature with LED warning and indicating lights (panel and stack)

Hydraulic high temperature shutoff feature (160 deg. F) with LED warning and indicating lights (panel and stack)

Engine no fuel and low fuel, high temperature, and low oil pressure LED indicating lights (panel and stack)

Lubricity and fuel/water separator with water-in-fuel (WIF) sensor

Low coolant shut down system

Pressure filter clogging indicator LED light with reset button

Pressure gauge calibration port for (on unit) calibration with safety shut-off valve

Emergency stop button, system pressure relief valve, maintenance only access panels, return system pressure relief valve, automatic warning and shutdown systems.

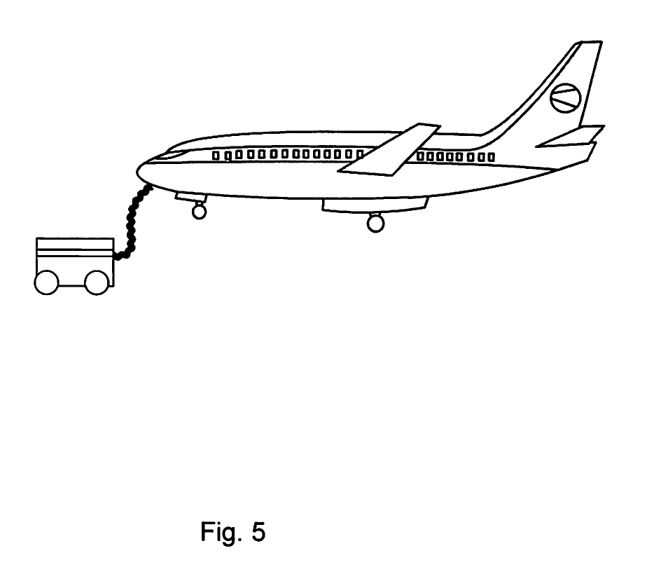

FIG. 5 is a general view showing a typical aircraft.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. An apparatus for servicing an aircraft, comprising a mobile vehicle;
a hydraulic power unit (HPU) detachably mounted to the vehicle;
the HPU further comprising a computer; and
the HPU being capable of providing hydraulic fluid and outputs.

2. An apparatus according to claim 1, wherein the HPU further comprises:
a hydraulic pump for producing a fluid hydraulic pressure output to the aircraft.

3. An apparatus according to claim 1 further comprising outputs for pressurized hydraulic fluid.

4. An apparatus according to claim 1 further comprising a gasoline engine for driving the HPU.

5. An apparatus according to claim 1 further comprising a diesel engine for driving the HPU.

6. An apparatus according to claim 1 capable of providing hydraulic fluid at a hydraulic pressure ranging from 250-1500 psi.

7. An apparatus according to claim 1 capable of providing hydraulic fluid at a hydraulic pressure ranging from 250 to 4000 psi.
